(19) United States
(12) Patent Application Publication
(10) Pub. No.: US 2006/0127163 A1
(43) Pub. Date: Jun. 15, 2006

(54) Tip holder for writing tips

(76) Inventors: Joerg Rahn, Heroldsberg (DE); Berthold Seitz, Weissenburg (DE)

Correspondence Address: BACHMAN & LAPOINTE, P.C., 900 CHAPEL STREET, SUITE 1201, NEW HAVEN, CT, 06510, US

(21) Appl. No.: 10/544,871

(22) PCT Filed: Apr. 22, 2005
(86) PCT No.: PCT/EP05/04378

§ 371 Date: Sep. 12, 2005

(30) Foreign Application Priority Data
Aug. 28, 2004 (DE) 20-2004-006-712.9
Apr. 28, 2004 (EP) 0400124.8

(51) Int. Cl. B43K 8/06

(52) U.S. Cl. 401/198

(57) ABSTRACT

A writing tip holder comprising a holding element which is provided for connection to a pen body or which when suitably prolonged forms the pen body, and a stabilisation sleeve. The stabilisation sleeve is connected integrally to the holding element by way of a connection and is made from the same material as the holding element or a material which is different from the material of the holding element, in particular a more elastic material.

### BACKGROUND OF THE INVENTION

The invention relates to an applicator tip holder for a reservoir feed portion which conveys an application liquid by capillary action, in particular for a fineliner reservoir feed portion.

On the one hand pens should have the optional functionality for their respective purpose of use, that is to say for example for writing or cosmetic purposes. On the other hand however those pens must be inexpensive to produce. Finally, in regard to the design of such pens, it is necessary to take account of the disposal thereof after the application or writing liquid has been used up. Those demands are in part in conflict with each other.

In regard to functionality, in the case of pens with reservoir feed portions or cartridges which convey an application liquid, in particular a writing liquid, by capillary action, it is to be borne in mind that those reservoir feed portions are extremely sensitive in relation to pressure forces and also bending forces. In particular the applicator tip of a writing pen is subjected to pressure forces of that kind but also bending forces during the application or writing process. So that the writing tip of the writing implement, which projects freely from the body of the pen, does not bend during the writing process or is already pushed into the interior of the body of the pen when low pressure forces are involved, known pens have a stabilisation sleeve. That sleeve is of an inside diameter which corresponds to the outside diameter of the reservoir feed portion or cartridge and it extends from a region which is disposed only slightly axially inwardly from the writing tip of the reservoir feed portion into the interior of a holding means, by way of which the reservoir feed portion is held jointly with the stabilisation sleeve to a pen body.

German laid-open application No. 42 25 312 discloses a writing pen with a holder for a writing tip of the kind set forth in the opening part of this specification, in which the stabilisation sleeve is mounted resiliently in the holding means in such a way that, when pressure forces act, the reservoir feed portion together with the stabilisation sleeve can retract reversibly into the interior of the pen body. In the case of that known writing implement the stabilisation sleeve is made of metal. Admittedly, that structure exhibits an optimum effect both in regard to stabilisation of the reservoir feed portion in the writing process and also in regard to the aspect of holding the reservoir feed portion to the pen body, but the use of metal for the stabilisation sleeve does not satisfy the further requirement which applies in respect of pens of that kind, namely inexpensive manufacture, as plastic materials are used for the rest of the pen body and for the holding means. For, problems arise inter alia for a pen upon assembly thereof by virtue of the use of materials which are very different in terms of their chemical and/or physical properties. In addition the combination of two different materials is disadvantageous, in regard to the disposal of pens which have been used up, as in general pens of that kind are disposed of by being incinerated, in which case the metal parts are left as a part which cannot be destroyed by heat, at the incineration temperatures which occur in that situation.

A further known writing tip holder for a writing pen which also has a stabilisation sleeve of metal and a holding means of plastic material is to be found in EP patent application No. 0 461 292.

The object of the present invention is to provide an applicator tip holder of the kind set forth in the opening part of this specification and a process for the production thereof, which on the one hand sufficiently stabilises and holds the reservoir feed portion but which on the other hand is inexpensive both in regard to production and also disposal.

### SUMMARY OF THE INVENTION

The foregoing object is attained by providing an applicator tip holder for a reservoir feed portion for conveying an application liquid by capillary action, comprising a stabilisation sleeve (40) receiving the reservoir feed portion (KM) in the assembled condition and having a first sleeve end (40a) which faces in the direction of an applicator tip (SP) of the reservoir feed portion (KM) and beyond which the reservoir feed portion (KM) projects with its applicator tip (SP) in the assembled condition and a second sleeve end (40b) which faces in the direction of a pen body, and a holding means (20) holding the reservoir feed portion (KM) in the assembled condition to the pen body and also having a first holding means end (20a) which faces in the direction of the applicator tip (SP) of the reservoir feed portion (KM) and a second holding means end (20b) which faces in the direction of the pen body, the stabilisation sleeve (40) being at least partially accommodated in the holding means, wherein the stabilisation sleeve (40) and the holding means (20) are integrally connected together. In this connection it is to be noted that the applicator tip holder can be used at least both in respect of writing pens and also cosmetic pens. Therefore hereinafter the terms ‘applicator pen’ and ‘writing pen’, ‘application liquid’ and ‘writing liquid’ etc are used synonymously. It is also to be noted that the terms ‘ink conductor’ and ‘reservoir feed portion’ or ‘cartridge’ are also used synonymously hereinafter.

By virtue of the integral configuration of the stabilisation sleeve with the holding means, there is the possibility of using only one single kind of material for both components. That can advantageously involve a plastic material which, upon thermal disposal of the pen after the application or writing liquid is used up, permits the exhausted pen to be completely eliminated. In addition depending on the respective production process selected the manufacturing procedure can be simplified and in that way the costs of such a pen can be considerably reduced.

In order to avoid damage to the reservoir feed portion in an application or writing process, for example by virtue of the user of the pen applying an excessive amount of application or writing pressure, it is further advantageous if the stabilisation sleeve is integrally connected to the holding means in such a way that the stabilisation sleeve together with the reservoir feed portion or the ink conductor is movable axially elastically with respect to the holding means. In that respect, the axial direction of the movement is the direction which at least approximately corresponds to the direction of the longitudinal center line of the holding means or the pen body. In that case, axial elasticity can be achieved for example by virtue of forming a portion of the stabilisation sleeve or the connecting portion between the stabilisation sleeve and the holding means, in such a way that the portion of the stabilisation sleeve or the connecting portion bulges out radially when corresponding pressure forces are applied and thus affords the reservoir feed portion or the reservoir feed portion together with the stabilisation sleeve the possibility of moving axially into the pen body and thus yielding elastically to the applied pressure. If radial elasticity should be desired for the ink conductor or for the ink conductor and the stabilisation sleeve, that can be afforded by a further portion at the stabilisation sleeve or however by the portions which have already been mentioned hereinbefore, in which case the radial elasticity is generally less than the axial elasticity. It will be appreciated that the tip holder according to the invention can also only be designed in such a way that there is only an axial movement for the reservoir feed portion or the ink conductor and the stabilisation sleeve.

In order to ensure axial elasticity, it is further advantageous if the holding means is hollow at least approximately throughout and if an intermediate space which preferably concentrically surrounds the stabilisation sleeve is provided between the inside wall of the hollow holding means and the outside wall of the stabilisation sleeve as far as the integral connection thereof to the holding means, wherein preferably the flexural stiffness or bulging stiffness of the integral connection is of a lower degree than that of the stabilisation sleeve and/or the holding means. The lower level of flexural stiffness or bulging stiffness of the integral connection can be achieved both by virtue of a suitable geometrical configuration of the integral connection and/or by a suitable choice of material for the integral connection.

The intermediate space also serves to permit the above-mentioned radial bulging of the stabilisation sleeve or of the integral connection for the axial elasticity and/or the radial mobility, which is possibly required, of the stabilisation sleeve or of the integral connection, with respect to the holding means.

A particularly good connection between the stabilisation sleeve and the holding means is achieved if the stabilisation sleeve is connected to the holding means, in particular to the inside of the holding means, by way of the second end of the stabilisation sleeve, which faces in the direction of the pen body. That structure can provide that, in a region between the integral connection of the second end of the stabilisation sleeve and the inside wall of the holding means and the portion with which the stabilisation sleeve fixedly embraces the reservoir feed portion, it is possible to provide the elasticity region which has already been referred to a number of times hereinbefore and which permits axial elasticity of the stabilisation sleeve. In that respect it is advantageous if the stabilisation sleeve and the intermediate space are arranged in concentric relationship with the longitudinal center line of the holding means. In that respect it is also advantageous if the axial length of the stabilisation sleeve is less than that of the holding means and if that portion of the stabilisation sleeve, which permits the at least axial mobility of the stabilisation sleeve and the ink conductor or the integral connection between the stabilisation sleeve and the holding means is of a greater axial length than that portion of the stabilisation sleeve which is in touching contact or holding contact with respect to the reservoir feed portion. That then provides an adequate bulging capability for axial mobility of the stabilisation sleeve and/or the ink conductor.

In this connection it is to be pointed out that only the joining of the third sleeve portion to the inside wall of the holding means, is referred to as the integral connection or material thickening. It will be appreciated that the material thickening and the third sleeve portion can also be referred to as the integral connection. The only decisive consideration is that, between the inside wall of the holding means and the outside of the stabilisation sleeve, there is a continuous, that is to say integral connection, which permits the axial and if desired radial mobility of the reservoir feed portion M or of the reservoir feed portion M and the stabilisation sleeve.

To afford a simple production process for an applicator tip holder having the advantages according to the invention, it is further preferred if the stabilisation sleeve has at least one first sleeve portion which extends from its first sleeve end and whose inside wall embraces and possibly holds the reservoir feed portion in the assembled condition, and a third sleeve portion which extends from its second sleeve end and which enlarges frustoconically from the first sleeve portion to the second sleeve end. In that case, the integral connection between the stabilisation sleeve and the holding means can be formed by a projection which extends radially in the direction of the inside wall of the holding means and which surrounds the second end of the stabilisation sleeve and at which the frustoconical configuration of the third sleeve portion ends. As has already been mentioned hereinbefore however the third sleeve portion and the projection with which the third sleeve portion is fitted to the inside wall of the holding means can also form the integral connection. In addition it can be provided in that respect that the stabilisation sleeve projects outwardly with at least its first sleeve portion, out of the first end of the holding means. In order to fix the reservoir feed portion with respect to the stabilisation sleeve, it can further be provided that in the assembled condition the reservoir feed portion is fixedly connected to the stabilisation sleeve, preferably by a force-locking connection such as for example by fusion, by hot glueing and the like.

In order to promote the axial mobility of the stabilisation sleeve, in particular the engagement movement thereof into the holding means or into the pen body, it is further advantageous if the integral connection and/or a portion of the stabilisation sleeve is provided with at least one venting aperture and preferably three venting apertures arranged equidistantly relative to each other.

As has already been set forth in the opening part of this specification, the integral configuration of the stabilisation sleeve with the holding means provides that it is possible to use just one single kind of material for both components. In this respect, as also already mentioned hereinbefore, this can advantageously be a plastic material such as for example polyamide, polyacetyl, polyester, polyethylene or polypropylene.

It will be appreciated however that the integral configuration of the stabilisation sleeve with the holding means can also be achieved if a respective different plastic material is used for each of the stabilisation sleeve and for the holding means. In such a case the tip holder according to the invention can be produced using the two-component technology. It would then be possible for the tip holder to be produced by a co-extrusion process in which the reservoir feed portion or the ink conductor is also processed as an insert portion, during the co-extrusion process.

A further possible way of producing the applicator tip holder according to the invention involves using an injection molding process in which preferably the ink conductor or the reservoir feed portion is possibly automatically positioned in the injection molding mold and a hot plastic material is injected therearound.

The stable connection between the stabilisation sleeve and the reservoir feed portion or the ink conductor can be made in various ways. Thus on the one hand there is the possibility that this is effected by a force-locking connection, preferably by fusion or hot glueing. Alternatively or possibly even as a supplement thereto, it can further be provided that the reservoir feed portion is fixedly connected to the stabilisation sleeve in positively locking relationship, preferably by at least one tooth configuration between the reservoir feed portion and the stabilisation sleeve.

A suitable material can be selected for the reservoir feed portion or the ink conductor, depending on the respective demands on the reservoir feed portion. In such a case the reservoir feed portion and the stabilisation sleeve can be made from different plastic materials. In order further to simplify the production procedure, it can also be provided that the reservoir feed portion and the stabilisation sleeve are made from the same plastic material.

As has already been set forth in the opening part of this specification, an essential factor in terms of economic success for pens of the kind being discussed here is production costs and thus the final price. Particularly when using the same plastic material for the stabilisation sleeve and the holding means, the applicator tip holder can be produced by an injection molding process, in which case the reservoir feed portion is connected possibly in the form of an insert portion in the injection molding process for the holding means and the stabilisation sleeve, in force-locking relationship and/or positively locking relationship to the stabilisation sleeve. If the stabilisation sleeve and the holding means are made from different plastic materials, it is possible to achieve particularly inexpensive production of the integrally interconnected stabilisation sleeve and holding means, if both are produced in a co-extrusion process, wherein the reservoir feed portion can possibly be connected in the form of an insert portion to the stabilisation sleeve in force-locking relationship in the co-extrusion operation. In principle however in that case the stabilisation sleeve and the holding means can also be made from the same plastic material.

In order to permit a simple connection between the holding means and the stabilisation sleeve which is integrally connected to the holding means, as well as the reservoir feed portion which is possibly already introduced into the stabilisation sleeve, with the pen body, it is further advantageous if, at its second end, the holding means has a connecting region for connection to the pen body. Equally there is the possibility that, at its second end, the holding means forms the pen body itself.

In regard to the process the foregoing object is attained wherein the stabilisation sleeve (40) and the holding means (20) are produced from the same plastic material by means of an injection molding process, wherein the reservoir feed portion (KM) is connected possibly in the form of an insert portion to the stabilisation sleeve (40) in locking relationship during the operation of injection molding the holding means (20) and the stabilisation sleeve.

In that respect it is also to be observed that the process according to the invention enjoys the same advantages as have already been described hereinbefore in connection with the applicator tip holder.

### BRIEF DESCRIPTION OF THE DRAWINGS

Further advantageous configurations and an embodiment by way of example of the invention are described hereinafter with reference to the drawings. The terms used in this respect ‘left’, ‘right’, ‘bottom’ and ‘top’ relate to the

Figures with the reference numerals and the Figure legends being normally readable. In the drawings:

FIG. 1 shows a view from the outside of an applicator tip holder according to the invention with inserted reservoir feed portion,

FIG. 2 shows a view in longitudinal section taken along line II-II in FIG. 1 of the applicator tip holder according to the invention,

FIG. 3 is a view on an enlarged scale in section taken along line III-III in FIG. 1, and

FIG. 4 is a partly broken-away detail view on an enlarged scale of the detail indicated at Z in FIG. 2.

### DETAILED DESCRIPTION

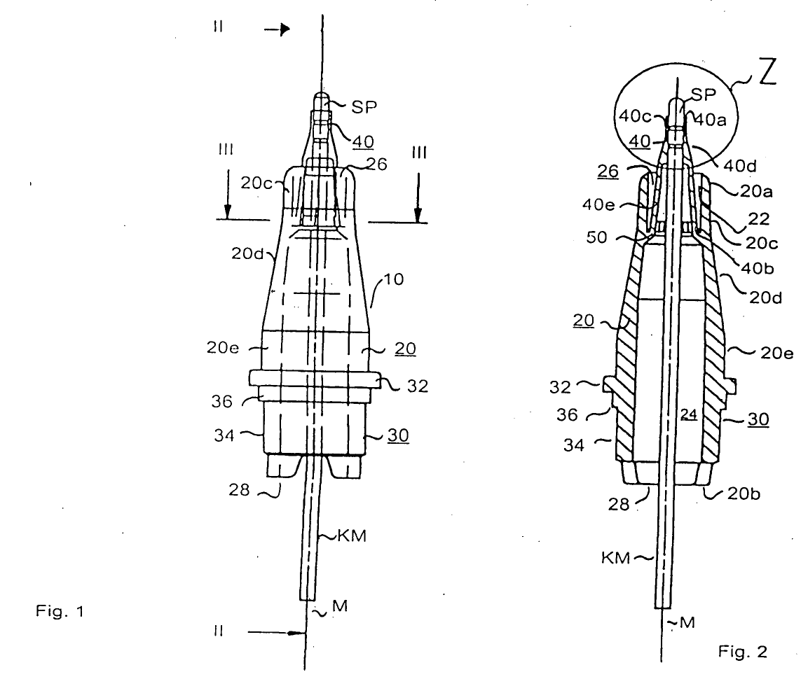

The applicator tip holder 10 shown in FIGS. 1 and 2 has a holding means 20 and a stabilisation sleeve 40 which are integrally connected together at a connection 50, as will be discussed in further detail hereinafter. Both the holding means 20 and also the stabilisation sleeve 40 are of a rotationally symmetrical configuration relative to a longitudinal center line M of the applicator tip holder 10. Arranged in coaxial relationship with the longitudinal center line M is a reservoir feed portion or cartridge for conveying an application or writing liquid by capillary action, or such an ink conductor KM, which has a writing tip SP projecting upwardly out of the stabilisation sleeve 40. The reservoir feed portion KM is stationarily fixed in the stabilisation sleeve 40 in a manner which will also be described in further detail hereinafter.

As FIG. 2 in particular shows, the elongate holding means 20 which is in the shape of the tip of a rocket which is cut off at the front end is hollow in the interior, with a first cavity portion 22 and a second cavity portion 24, as far as the integral connection 50 between the holding means 20 and the stabilisation sleeve 40. The first cavity portion 22 is separated from the second cavity portion 24 by the integral connection 50 or a portion, which belongs thereto, of the stabilisation sleeve 40.

At its first end 20a which faces in the direction of the writing tip SP, the holding means 20 has an opening 26, the plane of which extends substantially perpendicularly to the longitudinal center line M and by way of which the first cavity portion 22 is open outwardly. In that arrangement the first end 20a is provided at its outside edge with a convex rounding. At its second end 20b which faces away from the writing tip SP, the holding means 20 is also provided with an opening 28 whose plane extends substantially perpendicularly to the longitudinal center line M and by way of which the second cavity portion 24 is open outwardly.

The holding means 20 further has a total of three holding means portions 20c, 20d, 20e which occur in succession in the axial direction and which manifest themselves in particular at the outside of the holding means 20. The first portion 20c extends from the first end 20a of the holding means 20 in a direction facing away from the writing tip SP in the form of a cylinder, wherein the third portion 20e extends at least approximately in the form of a cylinder from the second end 20b of the holding means 20 in the direction of the writing tip SP. As can be seen in particular from FIG. 2 both the outside diameter and the inside diameter of the third portion 20e is larger than the outside diameter and the inside diameter respectively of the first portion 20c. In addition the second portion 20d connects the first portion 20c to the third portion 20e, wherein, as the outside and inside diameters of the third portion 20e are larger than the outside and inside diameters respectively of the first portion 20c, the second portion 20d is at least in part in the form of a truncated cone, both on the outside and also on the inside. In this connection it is also to be observed that the first cavity portion 22 extends from the first opening 26 to approximately the transition from the first portion 20c to the second portion 20d of the holding means 20 and accordingly the second cavity portion 24 extends from the second opening 28 to approximately the transition from the first portion 20c to the second portion 20d of the holding means 20. As can also be seen from FIG. 2 the second cavity portion 24 has a cylindrical region (not identified) and a frustoconical region (also not identified). The cylindrical region extends from the second opening 28 to approximately the center of the second portion 20d of the holding means 20. That is followed approximately as far as the transition between the first and second portions 20c, 20d of the holding means 20 by the frustoconical region of the second cavity portion 24.

At the third portion 20e the holding means 20 has a connecting region 30 which serves for fitting the applicator tip holder 10 to the writing body (not further shown) of a writing pen or the like, for example by glueing. In order to be able to position the writing body precisely with respect to the applicator tip holder 10, the connecting region 30, in the proximity of the axial center of the third portion 20e of the holding means 20, has a completely peripherally extending abutment collar 32 whose outside diameter is larger than that of the third portion 20e. In addition the connecting region 30 is provided with a connecting surface 34 extending from the second opening 28 in the direction of the writing tip SP. Also provided between the abutment collar 32 and the connecting surface 34 is an intermediate connecting surface 36 whose outside diameter is smaller than the outside diameter of the abutment collar 32 but larger than that of the connecting surface 34.

A further possible way of connecting the holding means 20 to the pen body (not further shown) is to provide in the connecting region 30 an annular groove which locks to a ridge or bead formed at the inside peripheral surface of the cavity in the pen body, upon fitting the holding means 20 to the pen body. An adhesive or the like can possibly also be used here. It is further to be observed in this respect that any other positively locking connection between the holding means 20 and the pen body is possible.

The stabilisation sleeve 40 also has a first sleeve end 40a facing in the direction of the writing tip SP and a second sleeve end 40b facing away from the writing tip SP. Provided both at the first and also the second sleeve end 40a, 40b is an opening (not identified), the surface of which respectively extends substantially perpendicularly to the longitudinal center line M of the writing tip holder 10 and by way of which the cavity of the stabilisation sleeve 40 is open outwardly on the one hand and to the second cavity portion 24 on the other hand.

The stabilisation sleeve 40 can again be divided into three sleeve portions 40c, 40d and 40e which occur in succession in the axial direction. The substantially cylindrical first sleeve portion 40c extends from the first sleeve end 40a in the direction of the second end 20b of the holding means 20. That is followed by the second sleeve portion 40d which is in the shape of a truncated cone. As can be seen from FIG. 2 however the truncated cone shape of the second sleeve portion 40d is limited to the outside so that, in the interior of the stabilisation sleeve 40, the cylindrical shape of the first sleeve portion 40c is continued. That also affords a material thickening which is to the benefit of the stabilisation function of the stabilisation sleeve 40. Finally the second sleeve portion 40d is adjoined by the third sleeve portion 40e which is again in the shape of a truncated cone. In this case however, in contrast to the second sleeve portion 40d, both the outside and also the inside are of the same configuration so that the shape of the internal cavity of the stabilisation sleeve 40 changes from a cylindrical shape to a frustoconical shape which is enlarged in the direction of the second end 20b of the holding means 20 and thus the wall thickness of the third sleeve portion 40e remains at least approximately uniformly thin. The transition from the cylindrical internal cavity portion of the stabilisation sleeve 40 to the frustoconical internal cavity portion of the sleeve 40 takes place in that case not uniformly but in the form of an abrupt change or a sudden increase in the size of the inside diameter of the cavity of the stabilisation sleeve 40.

As can be seen from FIG. 2 the stabilisation sleeve 40 is partially arranged in the interior of the holding means 20. With its first and second and in part the third sleeve portion 40c, 40d, 40e, it projects beyond the first end 20a of the holding means 20 through the first opening 26.

In addition the inside diameter of the first and second sleeve portions 40c, 40d is equal to the outside diameter of the reservoir feed portion KM, whereby the fixed connection described in greater detail hereinafter between the reservoir feed portion KM and the stabilisation sleeve 40 is made possible. In comparison the inside diameter of the third sleeve portion 40e is markedly larger than the outside diameter of the reservoir feed portion KM. Furthermore the outside diameters of the first, second and third sleeve portions 40c, 40d, 40e are markedly smaller than the inside diameter of the first portion 20c of the holding means 20 so that, in the region of the first cavity portion 22 of the holding means 20, between the outside wall of the third sleeve portion 40e which is approximately completely arranged in that first cavity portion, and the inside wall of the first portion 20c of the holding means 20, there is an intermediate space (not identified), the function of which will be described in greater detail hereinafter.

In the region of the second sleeve end 40b, the stabilisation sleeve 40 is integrally connected by way of the almost completely peripherally extending connection 50 to the inside wall of the holding means 20 in the region of the transition from its first portion 20c to the second portion 20d. In that case the connection 50 is effected by a material thickening. That thickening or integral connection 50 as well as the dimensioning of the third sleeve portion 40e of the stabilisation sleeve 40, in particular its outside diameter and the intermediate space which is formed thereby between the inside wall of the first portion 20c of the holding means 20 and the outside wall of the third portion 40e of the stabilisation sleeve provide that the stabilisation sleeve 40 can bulge in the direction of the inside wall of the first portion 20c of the holding means 20 in the region of the second sleeve portion 40d when a corresponding writing pressure is applied to the writing tip SP, whereby the first and second sleeve portions 40c, 40d together with the writing reservoir feed portion or cartridge KM fixedly connected thereto can move inwardly in the direction of the body of the pen into the holding means 20. In addition the thickening 50 in the transition between the stabilisation sleeve 40 and the holding means 20 can afford a slight degree of radial mobility of the stabilisation sleeve 40, in particular the first end 40a thereof, as that first end 40a can behave like a beam which is clamped at one end at the thickening 50.

In this connection it is to be pointed out that only the joining of the third sleeve portion 40e to the inside wall of the holding means 20 can be referred to as the integral connection or the material thickening 50. It will be appreciated that the material thickening 50 and the third sleeve portion 40e can also be referred to as the integral connection. The only decisive consideration is that, between the inside wall of the holding means and the outside of the stabilisation sleeve, there is a continuous, that is to say integral connection which permits the axial and if desired radial mobility of the reservoir feed portion M or the reservoir feed portion M and the stabilisation sleeve 40.

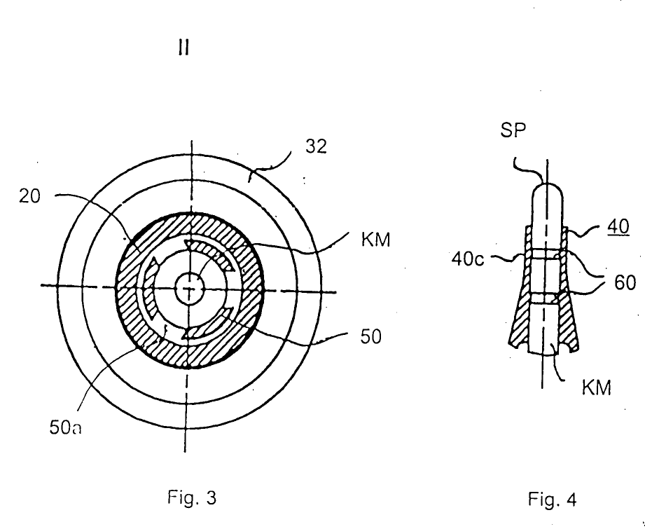

As can be seen from FIG. 3 the connection 50 or the third sleeve portion 40e has three venting apertures 50a arranged at equidistant spacings in the peripheral direction of the stabilisation sleeve 20. When the stabilisation sleeve 40 moves into the interior of the holding means 20, those venting apertures 50a firstly serve to permit the escape of the air which is disposed therein and which is now displaced. In addition the axial and/or possibly radial mobility of the stabilisation sleeve 40 and the reservoir feed portion KM can also be influenced by those venting apertures 50a. It is also to be noted here that the one or more venting apertures 50a can also be provided in the region of the third portion 40e of the stabilisation sleeve 40.

The thickening or connection 50 between the stabilisation sleeve 40 and the holding means 20 is illustrated in the present embodiment as extending completely around the periphery. To save on material and/or to influence the axial and/or radial elasticity however the connection 50 can also be of such a configuration as to extend only in portion-wise manner in the peripheral direction. Likewise, the wall thickness of the third sleeve portion 40e can be altered or the geometry of the wall of that sleeve portion 40e can be designed, to influence the axial and/or radial elasticity.

The fixed connection between the stabilisation sleeve 40 and the reservoir feed portion KM, as has already been mentioned hereinbefore, can be effected by a positively locking and/or force-locking connection. FIG. 4 shows a force-locking connection between the ink conductor KM and the stabilisation sleeve 40, wherein two annular grooves 60 which are at a spacing relative to each other in the axial direction are ground into the reservoir feed portion KM in the region of the first sleeve portion 40c of the stabilisation sleeve 40.

Then, as shown in FIG. 4, the material of the stabilisation sleeve 40 can engage into those annular grooves 60 upon connecting the applicator tip holder according to the invention and the ink conductor KM. That can be effected mechanically, in which case the stabilisation sleeve 40 is provided in the region of its first portion 40c with annular ridges or beads provided in the region of the two annular grooves 60 in the reservoir feed portion KM. Equally that can be effected by a procedure whereby, in an injection molding process or a co-extrusion process, the material of the stabilisation sleeve 40, which is then still soft, flows into the two annular grooves 60 in the region of the first portion 40c of the stabilisation sleeve.

The applicator tip holder 10 according to the invention can be produced in two different ways. On the one hand there is the possibility of the applicator tip holder 10 being produced by means of an injection molding process, in which case possibly the reservoir feed portion KM is connected in the form of an insert portion directly to the applicator tip holder 10, in particular the stabilisation sleeve 40. That is advantageous in particular when the stabilisation sleeve 40 and the holding means 20 are made from the same plastic material. If in contrast the applicator tip holder 10 is produced in such a way that different plastic materials are used for the holding means 20 and the stabilisation sleeve 40, that can be effected by means of a co-extrusion process in which then also the reservoir feed portion KM is joined in the form of an insert portion possibly at the same time to the stabilisation sleeve 40.

1-21. (canceled)

22. An applicator tip holder for a reservoir feed portion for conveying an application liquid by capillary action, comprising a stabilisation sleeve (40) receiving the reservoir feed portion (KM) in the assembled condition and having a first sleeve end (40a) which faces in the direction of an applicator tip (SP) of the reservoir feed portion (KM) and beyond which the reservoir feed portion (KM) projects with its applicator tip (SP) in the assembled condition and a second sleeve end (40b) which faces in the direction of a pen body, and a holding means (20) holding the reservoir feed portion (KM) in the assembled condition to the pen body and also having a first holding means end (20a) which faces in the direction of the applicator tip (SP) of the reservoir feed portion (KM) and a second holding means end (20b) which faces in the direction of the pen body, the stabilisation sleeve (40) being at least partially accommodated in the holding means, wherein the stabilisation sleeve (40) and the holding means (20) are integrally connected together.

23. An applicator tip holder as set forth in claim 22, wherein the stabilisation sleeve (40) is integrally connected to the holding means (20) so that it is movable together with the reservoir feed portion (KM) axially elastically with respect to the holding means (20).

24. An applicator tip holder as set forth in claim 22, wherein the holding means is hollow and, provided between an inside wall of the hollow holding means (20) and an outside wall of the stabilisation sleeve (40) as far as its integral connection (50) to the holding means (20), is an intermediate space which concentrically surrounds the stabilisation sleeve (40), wherein the bending strength of the integral connection (50) is less than that of the stabilisation sleeve (40) and the holding means (20).

25. An applicator tip holder as set forth in claim 24, wherein the stabilisation sleeve (40) is connected to the inside wall of the holding means (20), by way of the second end (40b) of the stabilisation means, which faces in the direction of the pen body.

26. An applicator tip holder as set forth in claim 24, wherein the stabilisation sleeve (40) and the intermediate space are arranged in concentric relationship with the longitudinal center line (M) of the holding means (20).

27. An applicator tip holder as set forth in claim 24, wherein the stabilisation sleeve (40) firstly has a first sleeve portion (40c) which extends from the first sleeve end (40a) and has an inside wall which encloses the reservoir feed portion (KM) in the assembled condition, and a third sleeve portion (40e) which extends from its second sleeve end (40b) and which enlarges frustoconically from the first sleeve portion (40c) to the second sleeve end (40b).

28. An applicator tip holder as set forth in claim 27, wherein the integral connection (50) between the stabilisation sleeve (40) and the holding means (20) is formed by a projection which extends radially in the direction of the inside wall of the holding means (20) and which surrounds the second sleeve end (40b) of the stabilisation sleeve (40) and at which the truncated cone of the third sleeve portion (40e) ends.

29. An applicator tip holder as set forth in claim 28, wherein the stabilisation sleeve (40) projects with at least its first sleeve portion (40c) out of the first holding means end (20).

30. An applicator tip holder as set forth in claim 22, wherein at least one of the integral connection (50) and the stabilisation sleeve (40) is provided with at least one venting aperture (50a).

31. An applicator tip holder as set forth in claim 22, wherein at least one of the integral connection (50) and the stabilisation sleeve (40) is provided with three equidistantly spaced venting apertures (50a).

32. An applicator tip holder as set forth in claim 22, wherein the stabilisation sleeve (40) and the holding means (20) are made from the same plastic material.

33. An applicator tip holder as set forth in claim 22, wherein the stabilisation sleeve (40) and the holding means (20) are made from two different plastic materials.

34. An applicator tip holder as set forth in claim 33, wherein the holding means (20) is made from a thermosetting material and the stabilisation sleeve (40) is made from a thermoplastic material.

35. An applicator tip holder as set forth in claim 22, wherein the reservoir feed portion (KM) is fixedly connected to the stabilisation sleeve (40) in force-locking relationship.

36. An applicator tip holder as set forth in claim 35, wherein the fixed connection is by fusion or hot glueing.

37. An applicator tip holder as set forth in claim 22, wherein the reservoir feed portion (KM) is fixedly connected to the stabilisation sleeve (40) in positively locking relationship by at least one tooth arrangement between the reservoir feed portion (KM) and the stabilisation sleeve (40).

38. An applicator tip holder as set forth in claim 37, wherein the reservoir feed portion (KM) and the stabilisation sleeve (40) are made from the same plastic material.

39. An applicator tip holder as set forth in claim 37, wherein the reservoir feed portion (KM) and the stabilisation sleeve (40) are made from different plastic materials.

40. An applicator tip holder as set forth in claim 22, wherein the second holding means end (20b) has a connecting region (30) for connection to the pen body.

41. An applicator tip holder as set forth in claim 22, wherein the second holding means end (20b) forms the pen body.

42. A process for the production of the applicator tip holder as set forth in claim 22, wherein the stabilisation sleeve (40) and the holding means (20) are produced from the same plastic material by means of an injection molding process, wherein the reservoir feed portion (KM) is connected possibly in the form of an insert portion to the stabilisation sleeve (40) in locking relationship during the operation of injection molding the holding means (20) and the stabilisation sleeve.

43. A process for the production of the applicator tip holder as set forth in claim 22, wherein the stabilisation sleeve (40) and the holding means (20) are produced from two different plastic materials by means of a co-extrusion process, wherein the reservoir feed portion (KM) is connected as an insert portion to the stabilisation sleeve (40) in locking relationship during the co-extrusion process.

44. A process for the production of the applicator tip holder as set forth in claim 43, wherein the locking connection between the holding means (20) and the reservoir feed portion (KM) is effected by fusion.
